(19) United States
(12) Patent Application Publication
(10) Pub. No.: US 2026/0111683 A1
(43) Pub. Date: Apr. 23, 2026

(54) SYNERGISTIC COLLABORATION BETWEEN WEAK AND STRONG LANGUAGE MODELS

(71) Applicant: Microsoft Technology Licensing, LLC, Redmond, WA (US)

(72) Inventors: Xuchao ZHANG, Sammamish, WA (US); Saravanakumar Rajmohan, Redmond, WA (US); Rujia Wang, Chicago, IL (US); Chetan Bansal, Seattle, WA (US); Yizhu Jiao, Urbana, IL (US)

(21) Appl. No.: 19/000,030

(22) Filed: Dec. 23, 2024

Related U.S. Application Data
(60) Provisional application No. 63/710,435, filed on Oct. 22, 2024.

(51) Int. Cl. G06F 40/40; G06F 40/30; G06N 3/0475; G06N 3/096

(52) U.S. Cl. CPC G06F 40/40; G06F 40/30; G06N 3/0475; G06N 3/096

(57) ABSTRACT

Described herein are techniques for improving language model performance through collaborative interaction between specialized and general-purpose models. A specialized model with fewer than ten billion parameters undergoes supervised fine-tuning on domain-specific data and generates initial outputs. These outputs are refined by a general-purpose model having over one hundred billion parameters and advanced reasoning capabilities. The framework implements preference tuning where outputs from both models are evaluated to generate preference triplets that optimize the performance of the specialized model. This approach achieves significant accuracy improvements while maintaining data privacy and computational efficiency.

### RELATED APPLICATIONS

This application claims the benefit under 35 U.S.C. §119(e) of U.S. Provisional Patent Application No. 63/710,435 , filed Oct. 22, 2024, entitled “SYNERGISTIC WEAK-STRONG COLLABORATION BY ALIGNING PREFERENCES,” which is hereby incorporated by reference in its entirety.

### TECHNICAL FIELD

The present disclosure relates generally to natural language processing systems, and more particularly to methods for collaborative processing between language models of different capabilities. Specifically, the disclosure describes techniques for combining specialized “weak” language models having less than some first specific number (e.g., ten billion) of parameters with “strong” language models having over some second specific number (e.g., one-hundred billion) of parameters to enhance performance on domain-specific tasks while maintaining computational efficiency. The disclosure further relates to systems and methods for optimizing weak language models through preference alignment with strong language models to achieve improved task performance without requiring direct modification of large model parameters. The technical field encompasses machine learning, artificial intelligence, and specifically the development of synergistic relationships between language models of varying sizes and capabilities to address specialized processing tasks while overcoming computational and privacy constraints inherent in large model fine-tuning.

### BACKGROUND

Generative language models, and in particular Large Language Models (LLMs), have demonstrated exceptional capabilities in general reasoning, problem-solving, and natural language understanding across a broad range of tasks. However, these language models face significant limitations when dealing with specialized tasks or domains that require proprietary information or information that is generally underrepresented in their training data. The immense size of these language models, often exceeding one-hundred billion parameters, creates practical challenges for deployment and adaptation to specific domains. Direct training or fine-tuning of large models for every specific domain or task is often impractical due to two key constraints: the substantial computational costs associated with fine-tuning models of such scale, and the inaccessibility of internal parameters in “black-box” models like GPT-4 from OpenAI®. Here, the term “black box” model refers to having internal parameters or weights that are inaccessible, and as such, cannot be easily modified.

### BRIEF DESCRIPTION OF THE DRAWINGS

Embodiments of the present invention are illustrated by way of example and not limitation in the figures of the accompanying drawings, in which:

FIG. 1 is a diagram illustrating a first training stage according to some embodiments, showing supervised fine-tuning of a weak model using domain-specific training data including queries and ground truth.

FIG. 2 is a diagram illustrating a second training stage according to some embodiments, showing preference tuning of the weak model based on evaluations of collaborative outputs between weak and strong models.

FIG. 3 is a diagram illustrating an inference stage according to some embodiments, showing collaborative interaction between the fine-tuned weak model and strong model to generate final outputs.

FIG. 4 is a block diagram illustrating an example computing system architecture according to some embodiments, which can be used to implement the collaborative language model methods described herein.

### DETAILED DESCRIPTION

Described herein are methods and systems for improving language model performance through collaborative interaction between a specialized “weak” model and a general-purpose “strong” model. The weak model, having fewer parameters and being fine-tuned on domain-specific data, generates initial outputs that are refined by the advanced reasoning capabilities of the strong model. Through preference tuning based on evaluative feedback, the outputs of the weak model are optimized to enhance the collaborative performance. In the following description, for purposes of explanation, numerous specific details are set forth regarding model architectures, training procedures, and evaluation metrics to provide a thorough understanding of the various aspects of different embodiments of the present invention. It will be evident, however, to one skilled in the art that the present invention may be practiced without all of these specific details.

For purposes of this patent application, the terms “weak” and “strong”, as used to describe models (e.g., weak model and strong model) refer to specific categories of language models distinguished by their architectural characteristics, computational requirements, and demonstrated capabilities. A weak model, as used herein, refers to a generative language model having fewer than ten billion parameters, making it computationally efficient and suitable for hosting on local computing resources. Such models are characterized by their ability to be fine-tuned through supervised training and preference optimization for specific domains, though they may demonstrate more limited generalization capabilities compared to larger models.

Conversely, a strong model, as used herein, refers to a generative language model having over one hundred billion parameters and typically trained on diverse datasets exceeding one terabyte in size. These models are generally referred to as Large Language Models (LLMs), and demonstrate advanced reasoning and problem-solving abilities across multiple domains, robust performance on standardized benchmarks, and strong instruction-following capabilities. Strong models, such as LLMs, are typically hosted on cloud-based computing infrastructure due to their substantial computational requirements.

The distinction between weak and strong models may be evaluated through various performance metrics, including but not limited to standardized benchmark scores, reasoning capabilities, and context window size. However, it should be understood that these characteristics are relative rather than absolute, particularly given the rapid evolution of language model technology. For example, while current weak models may typically process context windows of 512 to 2048 tokens, and strong models may handle 4096 to 32,000 tokens or more, these ranges may shift as the technology advances. The key distinction lies in the combination of parameter count, training data volume, computational requirements, and demonstrated capabilities rather than any single metric.

Current LLMs face significant technical limitations when applied to specialized domains and tasks, despite their exceptional general reasoning capabilities. These limitations manifest in several critical technical challenges. For example, the black-box nature of popular commercial LLMs (such as GPT-4 and Gemini) makes it technically infeasible to directly modify or fine-tune their internal parameters for specialized tasks. Even when parameter access is possible, the sheer size of these models—often exceeding 70 billion parameters—makes fine-tuning computationally impractical and cost-prohibitive for domain-specific applications.

Furthermore, direct fine-tuning of large models introduces significant technical risks related to data security and privacy. The fine-tuning process requires exposing potentially sensitive domain-specific data to the model, creating vulnerabilities where proprietary information could be inadvertently memorized or leaked through the outputs of the model. This technical constraint makes it particularly challenging to adapt these models for use with private or proprietary domain-specific information while maintaining data confidentiality and regulatory compliance.

Existing approaches that attempt to extend the capabilities of LLMs to specialized domains often rely on static interaction mechanisms, such as using small models merely as knowledge retrievers or prompt generators. These rigid architectures fail to leverage the potential benefits of dynamic feedback between models and lack the ability to continuously optimize the performance of the specialized model based on the capabilities of the stronger model.

When dealing with specialized or niche tasks that are underrepresented in their training data, large models struggle to maintain their performance quality despite their broad knowledge base. This technical limitation becomes particularly acute in domains requiring access to proprietary information or specialized knowledge that may not have been included in the general training data of the large model.

These technical problems are further compounded by the computational resource constraints associated with hosting and deploying large language models, making it impractical to maintain separate large-scale models for each specific domain or task. The combination of these technical limitations creates a significant barrier to effectively leveraging the advanced capabilities of large language models in specialized domain applications while maintaining security, efficiency, and performance.

Consistent with some embodiments of the present invention, a collaborative framework enables interaction between two types of generative language models to overcome limitations of using LLMs alone for specialized tasks. For example, in certain embodiments, the framework facilitates cooperation between a smaller specialized generative language model and a larger general-purpose generative language model (e.g., LLM) through several key mechanisms.

Consistent with some embodiments, a specialized weak model with fewer parameters (for example, under ten billion) first undergoes supervised fine-tuning using domain-specific training data to develop competency in a target domain, for example, such as medical diagnosis, counterfactual reasoning, or ethical analysis. This specialized weak model may be computationally efficient and capable of being hosted on local computing resources rather than requiring cloud infrastructure.

According to certain embodiments, the specialized weak model generates initial domain-specific outputs in response to input queries, leveraging knowledge gained through fine-tuning. For instance, when processing medical queries, the specialized weak model may provide detailed clinical context that informs the subsequent processing. Concurrently, a general-purpose LLM (for example, having over one-hundred billion parameters) generates standalone outputs for the same queries using its advanced reasoning capabilities.

Some embodiments implement a preference tuning mechanism where both the standalone outputs from the general-purpose LLM and collaborative outputs are evaluated by an additional model based on factors such as reasoning coherence and consistency with ground truth. This evaluation process may generate preference triplets that identify scenarios where the specialized model's contribution enhances overall performance. In certain implementations, these preference triplets serve as training data to optimize the specialized weak model through direct preference optimization, enabling it to generate outputs that better complement the general-purpose model's capabilities.

The preference triplets that serve as training data each contain three key components: (i) the input query, (ii) the standalone output generated by the strong model, and (iii) the weak model's output. The weak model's output within each triplet is designated as either a positive or negative sample based on evaluation scores-it is marked as positive when the collaborative output's evaluation score exceeds the standalone strong model's score, and negative when it does not.

These triplets are used to optimize the weak model through direct preference optimization (DPO), where the model learns to generate outputs that better complement the strong model's capabilities. The optimization process adjusts the weak model's parameters by computing probability ratios between the current policy distribution and a reference policy distribution, using a logistic sigmoid function to increase the probability of generating outputs similar to positive samples while decreasing the probability of outputs similar to negative samples. This training approach enables the weak model to continuously improve its ability to generate domain-specific outputs that enhance rather than detract from the strong model's reasoning capabilities.

Embodiments implementing this collaborative approach may provide several advantages compared to previous techniques. By utilizing a smaller, specialized model in conjunction with a larger model, some implementations achieve enhanced performance while avoiding computational costs and privacy risks associated with fine-tuning large models directly. For example, certain embodiments have demonstrated significant improvements in accuracy across different specialized domains—including an average F1 score improvement of 3.24% over using the specialized model alone and 12.17% over the general-purpose model alone across benchmarks.

The dynamic preference tuning mechanism in some embodiments enables continuous improvement of the specialized weak model's performance without requiring direct modification of the general-purpose model's parameters. This adaptive approach may significantly outperform static interaction schemes where smaller models serve only as knowledge retrievers. Additionally, certain implementations maintain data privacy by keeping sensitive domain-specific information within a locally-hosted specialized model while still leveraging the advanced reasoning capabilities of cloud-based general-purpose models. For example, in medical applications, patient data can remain secured within local infrastructure while still benefiting from the broader medical knowledge and reasoning capabilities of larger models. Other aspects and advantages of the various embodiments will be readily apparent from the detailed description of the several figures that follow.

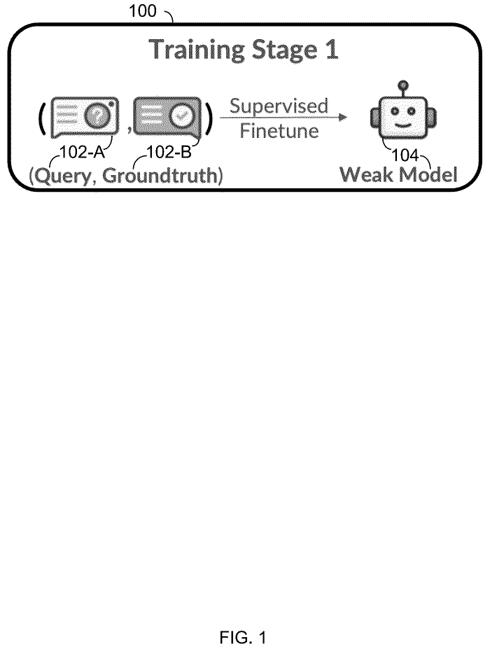

FIG. 1 is a diagram illustrating a first training stage according to some embodiments, showing supervised fine-tuning of a weak model using domain-specific training data including queries and ground truth.

As shown in FIG. 1, the training stage 100 implements supervised fine-tuning of a weak model 104 using domain-specific training data. The training data includes pairs of input queries 102-A and corresponding ground truth outputs 102-B that are relevant to a specific domain or task. For example, in medical applications, the training data may comprise clinical queries paired with correct diagnostic assessments, while for counterfactual reasoning tasks, the data may include hypothetical scenarios paired with appropriate logical analyses.

The weak model 104 represents a specialized language model having fewer than ten billion parameters, making it computationally efficient and suitable for fine-tuning on domain-specific tasks. During this initial training stage, the weak model 104 undergoes supervised learning to develop basic competency in processing queries within the target domain. This is achieved through a supervised fine-tuning process where the model learns to generate outputs that align with the provided ground truth data.

The supervised fine-tuning process adjusts the weak model's parameters to minimize the difference between its generated outputs and the ground truth data. This training enables the weak model 104 to develop specialized knowledge and capabilities specific to the target domain, while maintaining computational efficiency due to its reduced parameter count compared to larger models. The resulting fine-tuned weak model serves as the foundation for subsequent preference tuning stages where its performance will be further optimized through interaction with a strong model.

The supervised fine-tuning process shown in FIG. 1 implements a key training mechanism where the weak model 104 learns to maximize the likelihood of producing correct outputs for given input queries (or, prompts). Specifically, given an input query “x” and a model with policy “πθ”, the model is trained to maximize the likelihood of producing the correct output “y”. The training dataset “D” consists of pairs (x,y), where “x” represents the input query and “y” represents the corresponding target output.

The objective of the supervised fine-tuning process is to minimize the negative log-likelihood, expressed mathematically as:

$${L}_{SFT} ( π θ ) = - E ( x , y ) {∼}_{D} [ log πθ ( y \vert x ) ]$$

This optimization process adjusts the model's parameters to align its outputs with the labeled training data, providing a foundation for subsequent preference tuning techniques. The supervised fine-tuning stage enables the weak model to develop basic competency in processing domain-specific queries while maintaining computational efficiency due to its reduced parameter count.

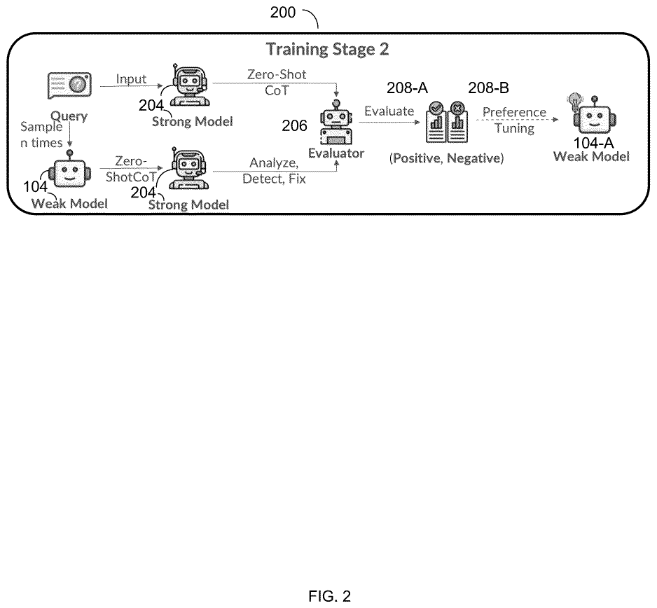

FIG. 2 is a diagram illustrating a second training stage according to some embodiments, showing preference tuning of the weak model based on evaluations of collaborative outputs between weak and strong models. As shown in FIG. 2, the second training stage 200 implements preference tuning of the weak model 104 through interaction with a strong model 204. The process begins with sampling input queries multiple times (n times) to generate a set of training examples. For each query, two parallel paths are executed: (1) the strong model 204 processes the query directly using zero-shot chain-of-thought prompting to generate standalone outputs by breaking down complex tasks into intermediate reasoning steps, and (2) the weak model 104 processes the query and its output is provided to the strong model 204, which analyzes the output to detect potential flaws or gaps in reasoning and fixes them through refinement. The “Analyze, Detect, Fix” step shown in the figure represents the strong model's process of examining the weak model's domain-specific output, identifying any issues in the reasoning or conclusions, and making necessary adjustments to improve the overall response quality.

An evaluator model 206 then assesses both the standalone outputs from the strong model and the collaborative outputs that combine contributions from both models. The evaluator, which may be implemented as an LLM with strong general capabilities, for example, such as GPT-4, performs a comprehensive evaluation based on two primary criteria: the reasoning coherence of the explanations provided in the output and the semantic consistency between the output and the corresponding ground truth data. This evaluation process employs a sophisticated scoring system that ranges, in some examples, from 1 to 10, where lower scores indicate major errors in both answers and explanations, while higher scores reflect increasingly accurate and well-reasoned responses. For example, a score of 1 indicates significant errors in both the answer and explanation, a score of 3 suggests partially correct answers with explanation errors, a score of 6 denotes semantically correct answers supported by reasonable explanations, and a score of 10 represents exact matches with ground truth accompanied by well-structured explanations. This model-based evaluation approach offers advantages over traditional metrics like BLEU or ROUGE by capturing not just surface-level similarities but also the depth of reasoning and logical coherence in the responses.

Here is a proposed rewrite of the paragraphs to improve clarity and readability:

Accordingly, these evaluations are used to generate preference triplets (208-A, 208-B) that identify scenarios where the weak model's contribution enhances overall performance. The preference triplets comprise: (i) the input query, (ii) the standalone output generated by the strong model, and (iii) the weak model's output. The weak model's output is designated as a positive sample when the evaluation score of the collaborative output exceeds the standalone output's score, and as a negative sample when it does not.

These triplets serve as training data for optimizing the weak model through direct preference optimization. The optimization process employs Low-Rank Adaptation (LoRA) with a rank and alpha value of 16, using a learning rate of 1.41e−5. Training is performed with a batch size of 1 and gradient accumulation over 16 steps to effectively increase the batch size, while utilizing the RMSProp optimizer. The process is conducted for one epoch with gradient checkpointing enabled and mixed-precision training to optimize memory usage.

The optimization process adjusts the weak model's parameters using a classification loss function that increases the probability of generating outputs similar to positive samples while decreasing the probability of outputs similar to negative samples. The parameter adjustment is performed by computing probability ratios between the current policy distribution and a reference policy distribution, then using a logistic sigmoid function to modify the model parameters.

While the specific parameter values described above have been found to be effective, in some embodiments different values may be employed based on factors such as available computational resources, model architecture, and training requirements. For example, the LoRA rank and alpha values may range from 4 to 64, the learning rate may be adjusted between 1e−6 and 1e−4, and the batch size and gradient accumulation steps may be varied to optimize training efficiency while maintaining model performance.

This preference tuning stage is important for aligning the weak model's outputs with the strong model's capabilities, enabling more effective collaboration during inference. The process leverages the strong model's advanced reasoning capabilities to guide the optimization of the weak model while maintaining the weak model's computational efficiency and domain specialization. The implementation allows for efficient training while preserving model performance through careful parameter management and optimization techniques.

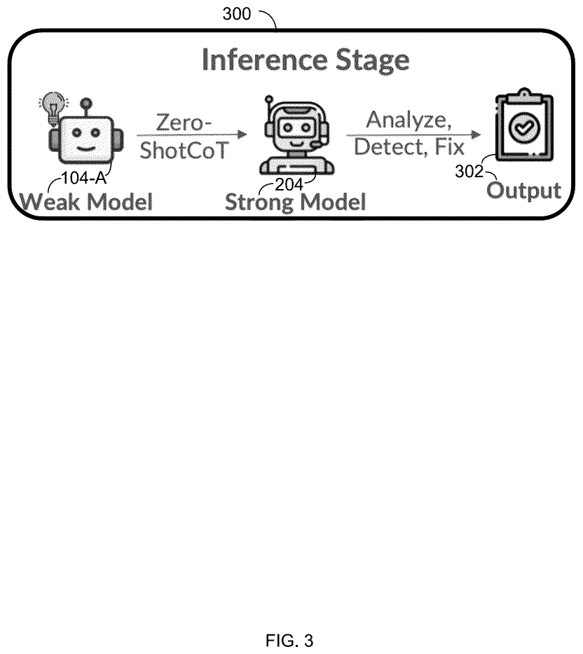

FIG. 3 is a diagram illustrating an inference stage according to some embodiments, showing collaborative interaction between the fine-tuned and optimized (e.g., through direct preference optimization) weak model and strong model to generate final outputs. As shown in FIG. 3, the inference stage 300 demonstrates how the optimized weak model 104-A and strong model 204 work together to process new queries and generate enhanced outputs 302. During inference, when a new query is received, the weak model 104-A first processes it using zero-shot chain-of-thought prompting to generate an initial domain-specific output. This output leverages the specialized knowledge and capabilities developed through the supervised fine-tuning (stage one) and preference tuning stages (stage two).

The strong model 204 then receives both the original query and the weak model's domain-specific output as input. Using its advanced reasoning capabilities, the strong model analyzes, detects potential issues, and refines the weak model's output to generate a final collaborative response 302. This collaborative process combines the domain-specific expertise of the weak model with the strong model's broader reasoning capabilities. For example, in medical applications, the weak model may generate an initial diagnostic assessment based on its specialized training on clinical data. The strong model then analyzes this assessment, checking for logical consistency and potentially adding broader medical context or identifying edge cases that should be considered. The final output 302 represents a synthesis that leverages both the weak model's domain expertise and the strong model's advanced reasoning capabilities.

In some embodiments, the inference stage architecture shown in FIG. 3 enables a distributed deployment where the weak model 104-A and strong model 204 may be hosted on different computing resources. For example, the weak model 104-A having fewer than ten billion parameters may be hosted on local computing infrastructure, while the strong model having over one hundred billion parameters may be accessed through cloud-based language model services.

This distributed architecture provides several significant technical advantages over prior approaches. First, by maintaining the weak model locally while accessing the strong model through cloud services, organizations can preserve strict control and privacy of sensitive domain-specific data while still leveraging advanced reasoning capabilities. This addresses a fundamental limitation of traditional approaches that required exposing proprietary information to external systems during model fine-tuning, creating substantial security and compliance risks.

Second, the split deployment architecture dramatically reduces computational overhead compared to previous solutions. Rather than requiring organizations to locally maintain massive models exceeding one-hundred billion parameters, they can deploy specialized models under ten billion parameters on local infrastructure while accessing larger models' capabilities through cloud APIs. This makes the solution significantly more cost-effective and practical for domain-specific applications, particularly in resource-constrained environments.

Third, the distributed approach enables unprecedented flexibility in integrating with different strong model providers. Since the framework operates without requiring direct access to or modification of the strong model's parameters, organizations can leverage various commercial language model services like GPT-4 or Gemini as the strong model component. This overcomes the technical constraints of black-box commercial models while maintaining full access to their advanced capabilities.

Fourth, the architecture supports continuous improvement through an innovative preference-based optimization process that operates entirely within the locally-hosted weak model, eliminating any need to modify cloud-hosted strong model parameters. For example, in medical applications, healthcare providers can iteratively enhance their specialized clinical models while keeping sensitive patient data secured within local infrastructure, yet still benefit from the broad medical knowledge and reasoning capabilities of cloud-based models. This represents a significant advancement over previous static interaction approaches where smaller models served purely as knowledge retrievers.

### Machine and Software Architecture

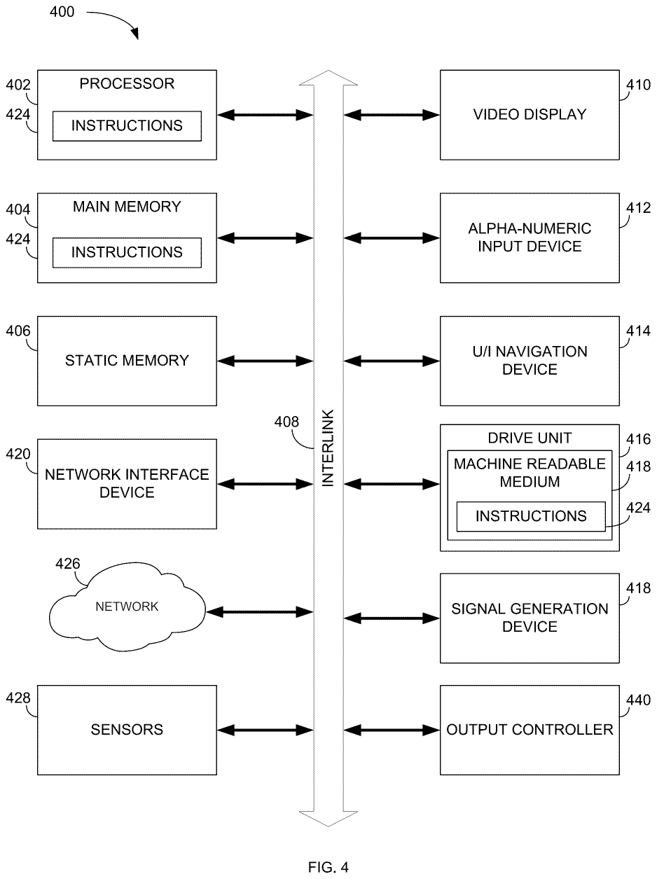

FIG. 4 illustrates a block diagram of an example machine 400 upon which any one or more of the techniques (e.g., methodologies) discussed herein for collaborative language model processing may be performed. In alternative embodiments, the machine 400 may operate as a standalone device or may be connected (e.g., networked) to other machines. In a networked deployment, the machine 400 may operate in the capacity of a server machine, a client machine, or both in server-client network environments. In an example, the machine 400 may act as a peer machine in peer-to-peer (P2P) (or other distributed) network environment. The machine 400 may be in the form of a server, desktop, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on one or more logic units, components, or mechanisms (hereinafter “components”). Components are tangible entities (e.g., hardware) capable of performing specified operations and may be configured or arranged in a certain manner. In an example, circuits may be arranged (e.g., internally or with respect to external entities such as other circuits) in a specified manner as a component. In an example, the whole or part of one or more computer systems (e.g., a standalone, client or server computer system) or one or more hardware processors may be configured by firmware or software (e.g., instructions, an application portion, or an application) as a component that operates to perform specified operations.

In an example, the software may reside on a machine readable medium. In an example, the software, when executed by the underlying hardware of the component, causes the hardware to perform the specified operations of the component. Accordingly, the term “component” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which component are temporarily configured, each of the components need not be instantiated at any one moment in time. For example, where the components comprise a general-purpose hardware processor configured using software, the general-purpose hardware processor may be configured as respective different components at different times. Software may accordingly configure a hardware processor, for example, to constitute a particular module at one instance of time and to constitute a different component at a different instance of time.

Machine (e.g., computer system) 400 may include one or more hardware processors, such as processor 402. Processor 402 may be a central processing unit (CPU), a graphics processing unit (GPU), a hardware processor core, or any combination thereof. Machine 400 may include a main memory 404 and a static memory 406, some or all of which may communicate with each other via an interlink (e.g., bus) 408. Examples of main memory 404 may include Synchronous Dynamic Random-Access Memory (SDRAM), such as Double Data Rate memory, such as DDR4 or DDR5.

Interlink 408 may be one or more different types of interlinks such that one or more components may be connected using a first type of interlink and one or more components may be connected using a second type of interlink. Example interlinks may include a memory bus, a peripheral component interconnect (PCI), a peripheral component interconnect express (PCIe) bus, a universal serial bus (USB), or the like. The machine 400 may further include a video display unit 410, an alphanumeric input device 412 (e.g., a keyboard), and a user interface (UI) navigation device 414 (e.g., a mouse, or similar). In an example, the display unit 410, input device 412 and UI navigation device 414 may be a touch screen display.

The machine 400 may additionally include a storage device (e.g., drive unit) 416, a signal generation device 418 (e.g., a speaker), a network interface device 420, and one or more sensors 428, such as a global positioning system (GPS) sensor, compass, accelerometer, or other sensor. The machine 400 may include an output controller 430, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.).

The storage device 416 may include a machine readable medium 422 on which is stored one or more sets of data structures or instructions 424 (e.g., software) embodying or utilized by any one or more of the techniques or functions described herein. The instructions 424 may also reside, completely or at least partially, within the main memory 404, within static memory 406, or within the hardware processor 402 during execution thereof by the machine 400. In an example, one or any combination of the hardware processor 402, the main memory 404, the static memory 406, or the storage device 416 may constitute machine readable media. While the machine readable medium 422 is illustrated as a single medium, the term “machine readable medium” may include a single medium or multiple media (e.g., a centralized or distributed database, and/or associated caches and servers) configured to store the one or more instructions 424.

The term “machine readable medium” may include any medium that is capable of storing, encoding, or carrying instructions for execution by the machine 400 and that cause the machine 400 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

Example communication networks may include a local area network (LAN), a wide area network (WAN), a packet data network (e.g., the Internet), mobile telephone networks (e.g., cellular networks), Plain Old Telephone (POTS) networks, and wireless data networks such as an Institute of Electrical and Electronics Engineers (IEEE) 802.11 family of standards known as Wi-Fi®, an IEEE 802.15.4 family of standards, a 5G New Radio (NR) family of standards, a Long Term Evolution (LTE) family of standards, a Universal Mobile Telecommunications System (UMTS) family of standards, peer-to-peer (P2P) networks, among others. In an example, the network interface device 420 may include one or more physical jacks (e.g., Ethernet, coaxial, or phone jacks) or one or more antennas to connect to the communications network 426. In an example, the network interface device 420 may include a plurality of antennas to wirelessly communicate using at least one of single-input multiple-output (SIMO), multiple-input multiple-output (MIMO), or multiple-input single-output (MISO) techniques. In some examples, the network interface device 420 may wirelessly communicate using Multiple User MIMO techniques.

What is claimed is:

1. A method for improving language model performance through model collaboration, the method comprising:
training a first generative language model using supervised fine-tuning on domain-specific training data relevant to a domain;
generating, using the trained first generative language model, a plurality of first domain-specific outputs responsive to a plurality of input queries;
preference tuning the trained first generative language model by:
generating a plurality of standalone outputs by providing as input to a second generative language model the plurality of input queries;
generating a plurality of collaborative outputs by providing as input to the second generative language model the plurality of input queries and the plurality of first domain-specific outputs;
for each input query in the plurality of input queries:
evaluating, using a third generative language model, a standalone output and a collaborative output associated with the input query to generate an evaluation score for each of the standalone output and the collaborative output, the respective evaluation scores based on the consistency of the respective outputs with ground truth data associated with the input query;
generating, for the input query, a preference triplet comprising: (i) the input query, (ii) the standalone output generated by the second generative language model, and (iii) the first domain-specific output, wherein the first domain-specific output is designated as a positive sample when the evaluation score of the collaborative output exceeds the evaluation score of the standalone output, and designated as a negative sample when the evaluation score of the collaborative output does not exceed the evaluation score of the standalone output; and
optimizing the first generative language model using the plurality of preference triplets as training data.

2. The method of claim 1, wherein optimizing the first generative language model using the plurality of preference triplets as training data comprises:
generating a conditional distribution of outputs for each input query according to a current policy of the first generative language model;
computing, for each preference triplet:
a first probability ratio between a current policy distribution and a reference policy distribution for outputs designated as positive samples, and
a second probability ratio between the current policy distribution and a reference policy distribution for outputs designated as negative samples; and
adjusting parameters of the first generative language model to increase the first probability ratio relative to the second probability ratio using a logistic sigmoid function.

3. The method of claim 1, further comprising:
receiving a new input query;
generating, using the optimized and trained first generative language model, a new domain-specific output responsive to the new input query;
providing as input to the second generative language model the new input query and the new domain-specific output to generate a collaborative output that combines domain-specific knowledge from the first generative language model with general reasoning capabilities of the second generative language model.

4. The method of claim 1, wherein the second generative language model comprises a general purpose generative language model having over one hundred billion parameters and trained on a diverse dataset exceeding one terabyte in size to enable advanced general reasoning capabilities across multiple domains; and
the first generative language model comprises a weak model having fewer than ten billion parameters.

5. The method of claim 4, wherein the second generative language model is hosted by first computing resources comprising a cloud-based language model service; and
the first generative language model is hosted by second computing resources different from the first computing resources.

6. The method of claim 1, wherein the third generative language model is configured to evaluate outputs based on reasoning coherence and consistency with ground truth data.

7. The method of claim 1, wherein evaluating the standalone output and the collaborative output comprises:
assigning, using the third generative language model, evaluation scores based on:
reasoning coherence of explanations provided in the output, and
semantic consistency between the output and corresponding ground truth;
wherein the evaluation scores reflect at least one of:
major errors in both answer and explanation,
partially correct answers with explanation errors,
semantically correct answers with reasonable explanations, or
exact matches with ground truth accompanied by reasonable explanations.

8. A system for improving language model performance through model collaboration, the system comprising:
memory storing domain-specific training data relevant to a domain; and
one or more processors configured to:
train a first generative language model using supervised fine-tuning on the domain-specific training data;
generate, using the trained first generative language model, a plurality of first domain-specific outputs responsive to a plurality of input queries;
preference tune the trained first generative language model by:
generating a plurality of standalone outputs by providing as input to a second generative language model the plurality of input queries;
generating a plurality of collaborative outputs by providing as input to the second generative language model the plurality of input queries and the plurality of first domain-specific outputs;
for each input query in the plurality of input queries:
evaluate, using a third generative language model, a standalone output and a collaborative output associated with the input query to generate an evaluation score for each of the standalone output and the collaborative output, the respective evaluation scores based on the consistency of the respective outputs with ground truth data associated with the input query;
generate, for the input query, a preference triplet comprising: (i) the input query, (ii) the standalone output generated by the second generative language model, and (iii) the first domain-specific output, wherein the first domain-specific output is designated as a positive sample when the evaluation score of the collaborative output exceeds the evaluation score of the standalone output, and designated as a negative sample when the evaluation score of the collaborative output does not exceed the evaluation score of the standalone output; and
optimize the first generative language model using the plurality of preference triplets as training data.

9. The system of claim 8, wherein optimizing the first generative language model using the plurality of preference triplets as training data comprises:
generating a conditional distribution of outputs for each input query according to a current policy of the first generative language model;
computing, for each preference triplet:
a first probability ratio between a current policy distribution and a reference policy distribution for outputs designated as positive samples, and
a second probability ratio between the current policy distribution and a reference policy distribution for outputs designated as negative samples; and
adjusting parameters of the first generative language model to increase the first probability ratio relative to the second probability ratio using a logistic sigmoid function.

10. The system of claim 8, wherein the one or more processors are further configured to:
receive a new input query;
generate, using the optimized and trained first generative language model, a new domain-specific output responsive to the new input query;
provide as input to the second generative language model the new input query and the new domain-specific output to generate a collaborative output that combines domain-specific knowledge from the first generative language model with general reasoning capabilities of the second generative language model.

11. The system of claim 8, wherein:
the second generative language model comprises a general purpose generative language model having over one hundred billion parameters and trained on a diverse dataset exceeding one terabyte in size to enable advanced general reasoning capabilities across multiple domains; and
the first generative language model comprises a weak model having fewer than ten billion parameters.

12. The system of claim 11, wherein:
the second generative language model is hosted by first computing resources comprising a cloud-based language model service; and
the first generative language model is hosted by second computing resources different from the first computing resources.

13. The system of claim 8, wherein the third generative language model is configured to evaluate outputs based on reasoning coherence and consistency with ground truth data.

14. The system of claim 8, wherein evaluating the standalone output and the collaborative output comprises:
assigning, using the third generative language model, evaluation scores based on:
reasoning coherence of explanations provided in the output, and
semantic consistency between the output and corresponding ground truth;
wherein the evaluation scores reflect at least one of:
major errors in both answer and explanation,
partially correct answers with explanation errors,
semantically correct answers with reasonable explanations, or
exact matches with ground truth accompanied by reasonable explanations.

15. A non-transitory computer-readable storage medium storing instructions that, when executed by one or more processors, cause the one or more processors to perform operations for improving language model performance through model collaboration, the operations comprising:
training a first generative language model using supervised fine-tuning on domain-specific training data relevant to a domain;
generating, using the trained first generative language model, a plurality of first domain-specific outputs responsive to a plurality of input queries;
preference tuning the trained first generative language model by:
generating a plurality of standalone outputs by providing as input to a second generative language model the plurality of input queries;
generating a plurality of collaborative outputs by providing as input to the second generative language model the plurality of input queries and the plurality of first domain-specific outputs;
for each input query in the plurality of input queries:
evaluating, using a third generative language model, a standalone output and a collaborative output associated with the input query to generate an evaluation score for each of the standalone output and the collaborative output, the respective evaluation scores based on the consistency of the respective outputs with ground truth data associated with the input query;
generating, for the input query, a preference triplet comprising: (i) the input query, (ii) the standalone output generated by the second generative language model, and (iii) the first domain-specific output, wherein the first domain-specific output is designated as a positive sample when the evaluation score of the collaborative output exceeds the evaluation score of the standalone output, and designated as a negative sample when the evaluation score of the collaborative output does not exceed the evaluation score of the standalone output; and
optimizing the first generative language model using the plurality of preference triplets as training data.

16. The non-transitory computer-readable storage medium of claim 15, wherein optimizing the first generative language model using the plurality of preference triplets as training data comprises:
generating a conditional distribution of outputs for each input query according to a current policy of the first generative language model;
computing, for each preference triplet:
a first probability ratio between a current policy distribution and a reference policy distribution for outputs designated as positive samples, and
a second probability ratio between the current policy distribution and a reference policy distribution for outputs designated as negative samples; and
adjusting parameters of the first generative language model to increase the first probability ratio relative to the second probability ratio using a logistic sigmoid function.

17. The non-transitory computer-readable storage medium of claim 15, wherein the operations further comprise:
receiving a new input query;
generating, using the optimized and trained first generative language model, a new domain-specific output responsive to the new input query;
providing as input to the second generative language model the new input query and the new domain-specific output to generate a collaborative output that combines domain-specific knowledge from the first generative language model with general reasoning capabilities of the second generative language model.

18. The non-transitory computer-readable storage medium of claim 15, wherein:
the second generative language model comprises a general purpose generative language model having over one hundred billion parameters and trained on a diverse dataset exceeding one terabyte in size to enable advanced general reasoning capabilities across multiple domains; and
the first generative language model comprises a weak model having fewer than ten billion parameters.

19. The non-transitory computer-readable storage medium of claim 18, wherein:
the second generative language model is hosted by first computing resources comprising a cloud-based language model service; and
the first generative language model is hosted by second computing resources different from the first computing resources.

20. The non-transitory computer-readable storage medium of claim 15, wherein evaluating the standalone output and the collaborative output comprises:
assigning, using the third generative language model, evaluation scores based on:
reasoning coherence of explanations provided in the output, and
semantic consistency between the output and corresponding ground truth;
wherein the evaluation scores reflect at least one of:
major errors in both answer and explanation,
partially correct answers with explanation errors,
semantically correct answers with reasonable explanations, or
exact matches with ground truth accompanied by reasonable explanations.
